(19) United States
(12) Patent Application Publication
(10) Pub. No.: US 2024/0059332 A1
(43) Pub. Date: Feb. 22, 2024

(54) FOLDING PUSHCART

(71) Applicant: Zenithen USA, LLC, d/b/a Z Company, Upland, CA (US)

(72) Inventors: Andrew David Frankel, Yorba Linda, CA (US); Shi-Ping Zheng, Fuzhou (CN); Tian-Xia Zheng, Fuzhou (CN)

(21) Appl. No.: 17/892,508

(22) Filed: Aug. 22, 2022

(30) Foreign Application Priority Data
Aug. 19, 2022 (CN) 202210996050.4

(51) Int. Cl. B62B 3/02

(52) U.S. Cl. CPC B62B 3/02; B62B 3/001

(57) ABSTRACT

A pushcart consisting of a folded and unfolded body frame and a storage bag enveloped on the body frame, whereas the body frame, including rigid left frame and right frame, and hinges that link left and right frames, front and rear ends, which form the whole body with left and right frames that can collide and be folded and unfolded, and the upper mouth and bottom of the bag can be opened by unfolded left and right frames.

### BACKGROUND OF THE INVENTION

### Field of the Invention

The invention relates to transportation equipment. More specifically, it relates to a type of folding pushcart and to a solution where its body frame's left and right frames can be folded and expanded.

### Technical Background

There are many existing folding pushcart schemes, which can be roughly divided into two categories. The first type is a one-dimensional flat folding scheme. The front and rear ends of the frame can be folded, but its structure is rigid. The second type involves two-dimensional folding, where the cart is folded into bundles. The four vertical surfaces of the front, rear, left, and right can be folded together and unfolded. There is also three-dimensional folding, which is easier to store than the former type, but rigidity is a little worse scheme in that its left and right sides of the frame are supported by shrinkable rod, and its front and rear vertical sides can be folded and unfolded.

CN2014800420171 shows a type of foldable pushcart, which has a foldable frame that can be positioned at the open position and the folded position, multiple wheels that are connected to the foldable frame, many rigid seats that are pivotally connected to the foldable frame; and flexible housing that forms the side walls around the foldable frame of the pushcart. Each seat has a rigid seat back and a rigid seat bottom hinged to the seat back. The supports on both sides of the folding frame are composed of two hinged quadrilateral rods, which can be lifted and folded along the central vertical surface.

CN201922213235.X shows a type of easy-to-use foldable pushcart, including a frame body, wheel assembly, and handle assembly. Both the left and right sides of the frame body adopt a telescopic structure that can be extended forward and retracted backward. The frame body can be folded or unfolded forward and backward. The bottom frame adopts a bottom hinged structure, which can be folded and unfolded along the front and rear frames. The forward and backward telescopic structure is a group of two cross diagonal rods, their upper and lower ends are hinged with the front and rear frames, forming a telescopic structure where the front and rear frames move toward the central vertical surface.

To overcome the deficiencies of present technology and provide a solution where no support structure is required at the bottom, is an object of this invention and research.

### SUMMARY OF THE INVENTION

A purpose of this invention is to invent a foldable pushcart that can be folded and unfolded at the left and right sides, with left and right frames that are rigid structure and front and rear ends that are hinged.

The technical plan of this invention was completed at least in part in the following manner:

A type of foldable pushcart, including a body frame that can be folded and unfolded, and a storage bag that is enveloped on the body frame. The cart can be pulled or pushed via the handle and wheels that are installed on the body frame. The features include a body frame with rigid left and right frames and hinges that connect the left frame and right frame, front and rear ends, and hinges form the whole body with the left and right frames that can be folded and unfolded. The storage bag consists of a bag bottom and surrounding bag walls. The top and bottom edge of the bags vertical surface correspond to the left and right frames, which are sewed with cloth tubes, via which the bag can be enveloped on left and right frames, and its upper edge and bottom can be opened by the unfolded left and right frames.

The hinges consist of two groups of hinge pieces at upper and lower portions, which share a hinge shaft. The hinge shaft has positioning points between the upper and lower hinge groups to prevent sliding along the shaft. The hinge on the body frame front directly locks and fixes on the front of the left and right frames. Extended frames are fastened on both pieces of the hinges. In the extended frame, it can be pivotally hinged with the rear end of the left and right frames. When the hinge opens to interference status and forms interference positioning, it supports the body frame similar to a triangle. The top of the hinge shaft on the front is hinged with a handle that can swing forwards and backwards. The lower end of the hinge shaft on the front is fixed on the wheel that supports the front end. Two wheels that support the rear end are fixed on the back lower of the left and right frames separately, forming a 3-wheel support structure. The storage bag has a cloth tube corresponding to the upper edge and bottom edge of the extended frame. Via the cloth tube, the bag is enveloped on two extended frames, and is tightened when the extended frames open to interference positioning.

All the left frame, the right frame and the extended frame of body frame individually have a folded U-shape rod, the U-shape rod consists of U bottom and two rod heads. The left and right frames are rigid, closed frames. A vertical rod is riveted between the two rod heads of the U-shaped rod via a top plastic part and bottom plastic part, two forward U-shape bottoms are hinged together. The two rod heads of the U-shape rods in the two extended frames are pivotally riveted with corresponding top plastic part and bottom plastic part on the same side. U bottoms are hinged together. The wheel on the rear end can be disassembled and assembled to the lower plastic part, while the wheel on the front end can be disassembled and assembled to the lower plastic part on the hinge shaft.

Both the left and right frames of the body frame have a rigid, quadrilateral closed frame that consists of two horizontal rods and two vertical rods that are tied together. Two upper plastic parts and two lower plastic parts are connected at the four corners. The extended frame is a folding U-shaped rod, with a U-shaped bottom and two rod heads. The two rod heads at the ends of the extended frame are pivotally riveted with corresponding upper plastic part and lower plastic parts on the same side. The U-shaped bottoms are hinged together, and the 4 wheels can be disassembled and assembled to the 4 lower plastic parts.

The hinge shaft of the hinge has two positioning points, one on the upper and another one on the lower. The upper point collides lower edge of upper hinge, the lower positioning point collides the upper edge of next hinge.

The wheel consists of a wheel body, support arm and snap socket. The snap socket consists of a bolt and hook. The bolt and hook are integrated at the bottom and form a contact plate with a diameter bigger than the bolt's diameter. Via the contact plate, it collides the surface of support arm, between the snap socket and colliding surface of the support arm there is a rivet or bolt that can play the function of rotary positioning; the wheel body is shaft positioned on the lower end of the support arm, the bolt of snap socket can plug into wheel plastic part at the lower end of the hinge shaft and the plug into the hole reserved on the lower plastic part, while the hook can buckle wheel plastic and into the groove hole on the lower plastic part, which forms the disassemble positioning of the wheel.

Between the two U-shape bottoms of extended frame, there is an interference buckle, which has an integrated ring envelop and clamp, the ring envelop can be enveloped on one side of U-shape rod, extend to its position, and via the clamp at the swing end, buckle in U-shape rod at another side, then forms interference clamp locking.

On top of the hinge shaft there is a handle seat, the handle seat has a positioning foot extending out at its bottom edge, the positioning foot stretches to the hinge piece surface, and its left right rotating angle can be restricted by a pair of hinges. The handle is rotatingly fixed on handle seat via a horizontal rivet.

The rear upper of handle seat has a positioning groove. An end of the handle is riveted in the positioning groove, and the rivet positioning point is lower than the surface of the handle seat.

This invention has a unique configuration, simple structure and both left and right side can be folded and unfolded; especially the front and rear ends of body frame are hinged, and interference positioning when unfolding, with better help of rigid frames at left and right sides, between the two sides of the storage bag can be tightened gradually during the spreading process, reaching the weight carrying requirement, without requiring additional support rod from the bottom, overcoming the deficiency of present forward and backward folding cart.

### BRIEF DESCRIPTION OF THE DRAWINGS

FIG. 1 shows a schematic diagram of the folding pushcart.

FIG. 2 shows a schematic diagram of the folding pushcart body frame.

FIG. 3 shows a zoomed schematic diagram of Selection A from FIG. 2.

FIG. 4 shows an illustration of an interference bracket.

FIG. 5 shows a schematic diagram of the folding pushcart in a collapsed state.

FIG. 6 shows a zoomed schematic diagram of Selection B from FIG. 5.

FIG. 7 shows a section diagram of the disassemble-able wheel structure.

FIG. 8 shows schematic diagram of relation between handle and hinge shaft.

FIG. 9 shows a schematic diagram of the quadrilateral body frame.

FIG. 10 shows a schematic diagram of the quadrilateral body frame in collapsed state.

Similar reference characters denote corresponding features consistently throughout the attached drawings. Namely, in the drawings the following reference numbers refer to the following part:

| | |
|---|---|
| 100 - Cart body frame | 34-bolt |
| 101-left frame | 4-extended frame |
| 102-right frame | 5-U-shape rod |
| 1-hinge | 51-U-shape bottom |
| 11-hinge shaft | 52-rod head |
| 12-hinge pieces | 6-vertical rod |
| 13-positioning point | 61-horizontal rod |
| 2-handle | 7-upper plastic part |
| 21-handle seat | 8-lower plastic part |
| 211-positioning foot | 81-wheel plastic part |
| 212-positioning groove | 811-plug-in hole |
| 22-handle's ring pull | 812-groove hole |
| 3-wheel | 9-interference buckle |
| 31-wheel body | 91-ring envelop |
| 32-support arm | 92-clamp |
| 33-snap socket | 200-Storage bag |
| 331-bolt/PIN | 201-bag bottom |
| 332-hook | 202-bag vertical side |
| 333-collide plate | 203-cloth tube |

### DETAILED DESCRIPTION OF THE PREFERRED EMBODIMENT(S)

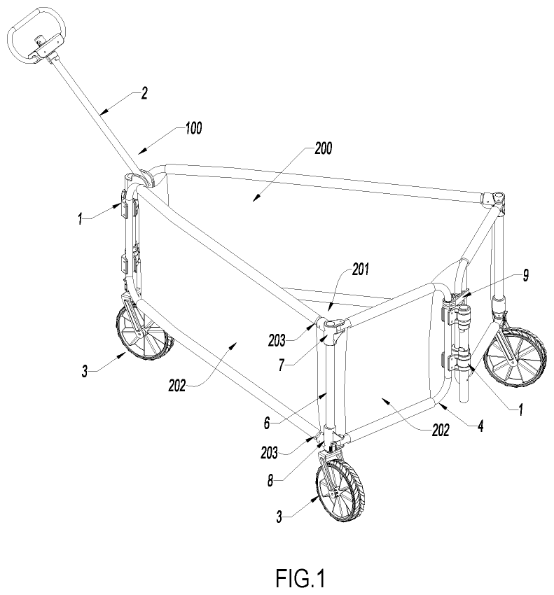

Referring to FIGS. 1, 2 and 5, a foldable pushcart, including foldable body frame 100 and storage bag 200 enveloped on the body frame is shown. Body frame 100, including rigid left frame 101 and right frame 102, and hinge 1 that connects left frame 101 and right frame 102 at front and rear end. The hinge 1 causes the left frame 101 and right frame 102 to fold and unfold. Together they form the whole body. Body frame 100 is fixed with handle 2 and wheel 3 and can be pulled or pushed via handle 2.

Storage bag 200 has bag bottom 201 and surrounding vertical sides 202. The upper edge and lower edge of vertical sides 202 corresponding to left frame 101 and right frame 102 have cloth tube 203. Via the cloth tube 203 the bag is enveloped on left frame 101 and right frame 102. The unfolded left frame 101 and right frame 102 will open (from inside) the upper mouth of storage bag 200 and bag bottom 201. Since the left and right are rigid frames, they can pull bag bottom 201 tight and carry weight, without requiring additional rod support at bottom.

Hinge 1 consists of a hinge shaft 11 and hinge pieces 12 that rotate around the hinge shaft 11 with positioning points. In this instance, hinge 1 consists of two groups hinge pieces 12 at upper and lower places and the hinge shaft 11 that they share. The hinge shaft 11 has two positioning points 13 between the upper and lower hinge pieces 12 to protect them to slide along the shaft. The two positioning points, one at the upper, another one at the lower, the upper positioning point 13 collides the lower edge of upper hinge pieces 12. The lower positioning point 13 collides the upper edge of next hinge pieces 12. That is, the two positioning points 13 are located on the shaft between the two hinge pieces 12, without requiring additional space.

The hinge with two groups of hinge pieces 12 share the same shaft, and can extend distance of rigid positioning. That is, it can keep the positioning of the left frame 101 and right frame 102 almost the same. The frond end and rear end of body frame 100 are connected with left frame 101 and right frame 102 via hinge 1, forming a whole body, which has the following two typical instances.

1. Triangle-Like Body Frame

Referring to FIGS. 1, 2 and 5, hinge 1 at front end of body frame directly locks on the front end of left frame 101 and right frame 102 via the hinge pieces 12. The hinge 1 on the rear end of body frame, with both hinge pieces 12 fastened with extended frame 4, are pivotally hinged with the rear ends of left frame 101 and right frame 102 via extended frame 4, when the hinge opens to interference status and forms interference positioning, and it supports triangle-like body frame. From another perspective, the extended frame 4 can be regarded as plus size hinge pieces 12, the width of the hinge pieces decides the width of body frame.

Link handle 2 and wheel 3, the forward and backward swing handle 2 is hinged at the end of hinge shaft 11 at the front end, wheel 3 that supports the front end is installed at lower end of shaft, two wheel 3 that support the back end are installed separately on the rear lower of left frame 101 and right frame 102, forming 3-wheel support structure, or 3-wheel pushcart style. Storage bag 200 also has cloth tube 203 at place corresponding to upper edge and lower edge of extended frame 4, so it can be enveloped on two extended frame 4 via cloth tube 203. It will be tightened when the extended frames 4 open to interference status, which fulfills vertical tightening.

A step further, composition of rigid frame in triangle body frame:

All the left frame 101, the right frame 102 and the extended frame 4 of body frame individually has a folded U-shape rod 5. The U-shape rod 5 consists of U bottom 51 and two rod heads 52. The left frame 101 and right frame 102 are rigid closed frames. A vertical rod 6 is riveted between the two rod heads 52 of U-shape rod via a top plastic part 7. Bottom plastic part 8, two forward U-shape bottoms 51 are hinged together via hinge 1. The two rod heads 52 of U-shape rods in the two extended frames 4 are pivotally riveted with corresponding top plastic part 7 and bottom plastic part 8 at the same side. The U bottoms 51 are hinged together via hinge 1. The wheel 3 on the rear end can be disassembled then assembled to the lower plastic part 8. The wheel 3 on the front end can be disassembled then assembled to the wheel plastic part 81 on the lower of hinge shaft 11. After folding, the three wheels 3 can be disassembled and collected to save package space.

2. Quadrilateral Body Frame:

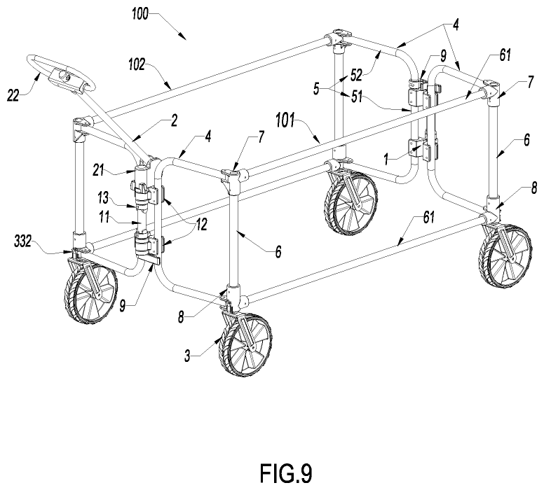

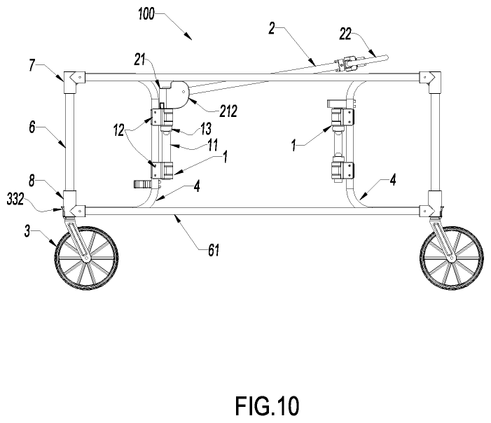

Referring to FIGS. 9 and 10, hinge 1 at front end and rear end of body frame 100, with both hinge pieces 12 are fastened with extended frame 4. Via extended frame 4, are pivotally hinged with corresponding frond end and rear end of left frame 101 and right frame 102. When the hinges 1 at front end and rear end open to interference status and form interference positioning, it supports quadrilateral body frame. That is, left side and right side of the body frame 100 show symmetry or corresponding relation, and front end and rear end show symmetry or corresponding relation. Two designs of rectangle body frame and trapezoid body frame could be planned.

Link handle 2 and wheel 3, the forward and backward swing handle 2 is hinged at the end of hinge shaft 11 at the front end. It is designed at the center, same with last instance; four wheel 3 are installed separately at the front lower and rear lower of left frame 101 and right frame 102, forming 4-wheel support structure, that is, ordinary 4-wheel pushcart. Storage bag 200 also has cloth tube 203 at place corresponding to upper edge and lower edge of extended frame 4, so it can be enveloped on two extended frame 4 via cloth tube 203. It will be tightened when the extended frames 4 open to interference status, which fulfills vertical tightening at both ends and opens a rectangle or trapezoid bag bottom 201.

A step further, composition of rigid frame in quadrilateral body frame:

Both the left frame 101 and right frame 102 of body frame have a rigid quadrilateral closed frame that consists of two horizontal rods 61 and two vertical rods 6 that are tied together. Two upper plastic parts 7 and two lower plastic parts 8 are connected at four corners, which forms a whole rectangle rigid frame. The extended frame 4 is a folding U-shape rod 5, with U-shape bottom 51 and two rod heads 52. The two rod heads 52 at the ends of two extended frame 4 at both ends are pivotally riveted with corresponding upper plastic part 7 and lower plastic parts 8 at same side. The U-shape bottoms 51 are hinged together via hinge 1. The four wheels 3 can be disassembled then assembled to the four lower plastic parts 8.

Further improvement on details design:

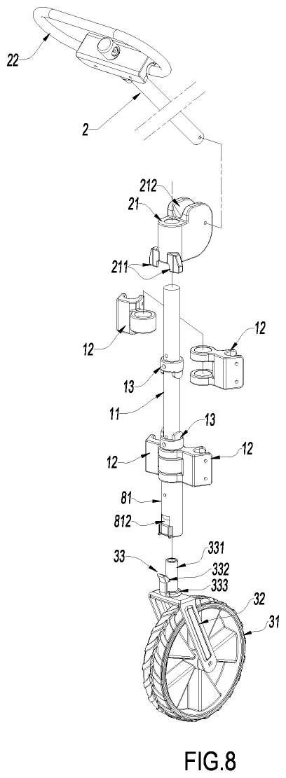

Referring to FIGS. 1, 7 and 8, the wheel 3 consists of wheel body 31, support arm 32 and snap socket 33; snap socket 33 has bolt/Pin 331 and hook 332. Bolt 331 and hook 332 are integrated at the bottom forming a contact plate 333 with diameter bigger than bolt 331's diameter. Via the contact 333, it collides on the surface of support arm 32. Between snap socket 33 and colliding surface of support arm 32, there is a rivet or bolt 34 that can play function of rotary positioning, which makes the support arm 32 (and) shaft(−) positioned on wheel body 31 under the support arm 32, with rotary trip. Bolt 331 of snap socket can plug into wheel plastic part 81 at lower part of hinge shaft 11, and plug into hole 811 reserved in lower plastic part 8, while hook 332 can buckle wheel plastic part 81 and into surface groove hole 812 of lower plastic part, which forms disassemble positioning for wheel 3. This diagram is wheel plastic part 81. Besides increasing functions of link rods, the lower plastic part 8 has the same disassemble structure when paired with wheel 3.

Referring to FIGS. 1, 3 and 4, interference positioning of extended frame 4 can increase buckle insurance. That is, between the two U-shape bottoms 51 there is an interference buckle 9, which has integrated ring envelop 91 and clamp 92. The ring envelop 91 can be enveloped on one side of U-shape bottom 51, extend to its position, and via the clamp 92 at the swing end, buckle in U-shape bottom 51 at another side, then forms interference clamp locking, which locks the interference status, and protects it from reversing accidently at foreign force.

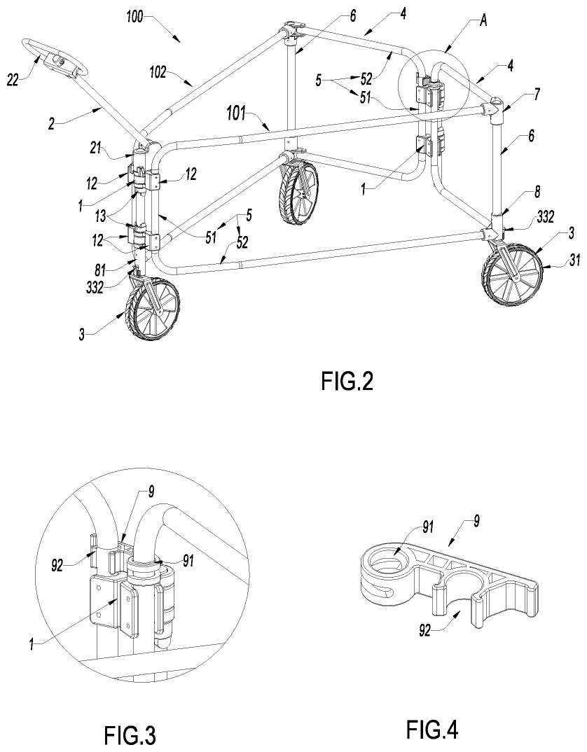

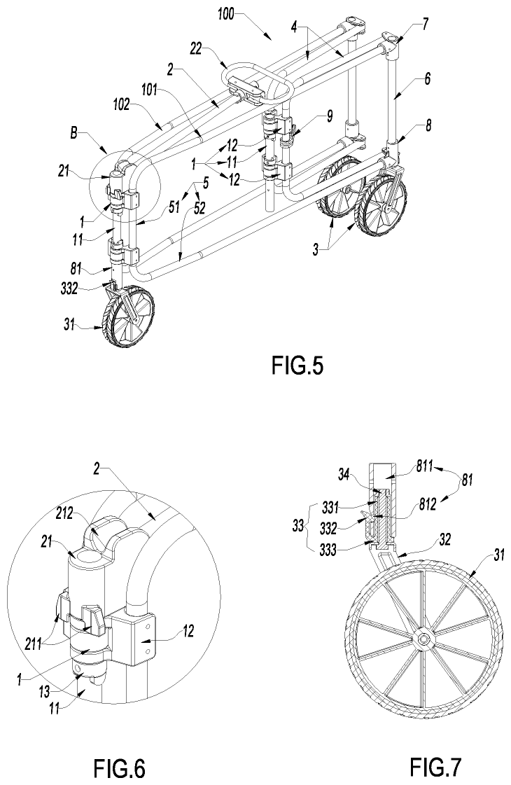

Referring to FIGS. 2, 5, 6 and 8, on top of the hinge shaft 11 there is a handle seat 21. The handle seat 21 has a positioning foot 211 extending out at its bottom edge, the positioning foot 211 stretches to the hinge piece 12 surface. Its left right rotating angle can be restricted by a pair of hinge pieces 12. The handle 2 is swing fixed on handle seat 21 via a horizontal rivet. More specifically, handle seat 21 has a positioning groove 212 at rear upper. The handle 2 end is positioned in the positioning groove 212 via a rivet. The rivet positioning point is lower than surface of handle seat 21, so that when handle 2 swings forward to designed position, it can be restricted by the surface of handle seat 21, not swing over to ground or touch the front end of body frame. Handle 2 is supported at a conveniently lift or pull workable angle range, but it is not restricted if swings backward. Via the handle ring pull 22 at the end, it can lie flat or lean on upper side when left frame 101 and right frame 102 collide together, as in FIG. 5 and FIG. 10, which saves space and is quite convenient when unfolding.

We claim:

1. A foldable pushcart, including a body frame that can be folded and unfolded and storage bag that is enveloped on the body frame, which can be pulled or pushed via the handle and wheels that are installed on the body frame;
a body frame, including the rigid left and right frames and the hinges that connect the left frame and right frame, front and rear ends, and hinges form the whole body with the left and right frames that can be folded and unfolded;
the storage bag consists of the bag bottom and surrounding bag walls, the top edge and bottom edge of the bag vertical surface corresponding to left and right frames are sewed with cloth tubes, via which the bag can be enveloped on left and right frames, and its upper edge and bottom can be opened by the unfolded left and right frames.

2. The folding pushcart according to claim 1, further comprising:
the hinges consist of two groups of hinge pieces at top and bottom, which share a hinge shaft;
the hinge shaft has positioning points between the top and bottom groups to prevent sliding along the shaft;
the hinge on the body frame front directly locks and fixes on the front of left and right frame, the hinge on the rear of the body frame, extended frames are fastened on both pieces of the hinges, via the extended frame they are pivotally hinged with the corresponding rear end of the left and right frames,
when the hinge opens to interference status and forms interference positioning, it supports the body frame similar to triangle; the top of hinge shaft on the front is hinged with handle that can swing forward and backward, the lower end of the hinge shaft on the front is fixed on the wheel that supports the front end, two wheels that support rear end are fixed on rear lower of left and right frames separately, forming 3-wheel support structure; the storage bag has cloth tube corresponding to upper edge and bottom edge of the extended frame, via the cloth tube the bag is enveloped on two extended frames, and it is tightened when extended frames open to interference positioning.

3. The folding pushcart according to claim 1, further comprising:
the hinges consist of two groups of hinge pieces at top and bottom, which share a hinge shaft;
the hinge shaft has positioning points between the top and bottom groups to prevent sliding along the shaft; the hinge, extended frames are fastened on both pieces of the hinges, via the extended frame they are pivotally hinged with corresponding front end and rear end of the left and right frames, when the hinge at front end or rear opens to interference status and forms interference positioning, it supports the body frame similar to quadrilateral; the top of hinge shaft on the front is hinged with handle that can swing forward and backward, four wheels are installed separately front lower and rea lower of left frame and right frame, forming 4-wheel support structure; the storage bag has cloth tube corresponding to upper edge and bottom edge of the extended frame, via the cloth tube the bag is enveloped on two extended frames, and it is tightened when extended frames open to interference positioning.

4. The folding pushcart according to claim 2, further comprising:
all the left frame, the right frame and the extended frame of body frame individually has a folded U-shape rod, the U-shape rod consists of U bottom and two rod heads; the left and right frames are rigid closed frames, a vertical rod is riveted between the two rod heads of U-shape rod via a top plastic part and bottom plastic part, two forward U-shape bottoms are hinged together; the two rod heads of U-shape rods in the two extended frames correspond to, and are riveted with the top plastic part and bottom plastic part at same side, and can rotate, the U bottoms are hinged together; the wheel on the rear end can be disassembled then assembled to the lower plastic part, while the wheel on the front end can be disassembled then assembled to the wheel plastic part on lower of the hinge shaft.

5. The folding pushcart according to claim 3, further including:
both the left and right frames of body frame have a rigid quadrilateral closed frame that consists of two horizontal rods and two vertical rods that are tied together, two upper plastic parts and two lower plastic parts are connected at four corners; the extended frame is a folding U-shape rod, with U-shape bottom and two rod heads; the two rod heads at the ends of extended frame are pivotally riveted with corresponding upper plastic part and lower plastic parts at same side, the U-shape bottoms are hinged together; the 4 wheels can be disassembled then assembled to the 4 lower plastic parts.

6. The folding pushcart according to claim 2, further including:
the hinge shaft of hinge has two positioning points, one on the upper, another one on the lower, the upper point collides lower edge of upper hinge, the lower positioning point collides the upper edge of next hinge.

7. The folding pushcart according to claim 4, further including:
the wheel consists of wheel body, support arm and snap socket; the snap socket has bolt/Pin and hook, bolt and hook are integrated at bottom, forming a contact plate with diameter bigger than bolt's diameter, via the contact plate, it collides on the surface of support arm, between snap socket and colliding surface of support arm, there is a rivet or bolt that can play function of rotary positioning; the wheel body is shaft positioned on lower end of support arm; bolt of snap socket can plug into wheel plastic part at lower end of hinge shaft, and plug into hole reserved in lower plastic part, while hook can buckle wheel plastic part and into surface groove hole of lower plastic part, which forms disassemble positioning for wheel 3.

8. The folding pushcart according to claim 4, wherein between the two U-shape bottoms of extended frame, there is an interference buckle, which has integrated ring envelop and clamp, the ring envelop can be enveloped on U-shape rod at one side, extend to its position, and via the clamp at the swing end, buckle in U-shape rod at another side, then forms interference clamp locking.

9. The folding pushcart according to claim 3, wherein on top of the hinge shaft there is a handle seat, the handle seat has a positioning foot extending out at its bottom edge, the positioning foot stretches to the hinge piece surface, and its left right rotating angle can be restricted by a pair of hinge pieces; the handle is swing fixed on handle seat via a horizontal rivet.

10. The folding pushcart according to claim 9, wherein the rear upper of handle seat has a positioning groove, end of the handle is riveted in the positioning groove, and the rivet positioning point is lower than the surface of the handle seat.
